(19) United States
(12) Patent Application Publication
(10) Pub. No.: US 2014/0319303 A1
(43) Pub. Date: Oct. 30, 2014

(54) SUPPORT DEVICE

(71) Applicant: Hon Hai Precision Industry Co., Ltd., New Taipei (TW)

(72) Inventors: CHANG-MING KUAN, New Taipei (TW); MING-CHIEN CHIU, New Taipei (TW)

(73) Assignee: HON HAI PRECISION INDUSTRY CO., LTD., New Taipei (TW)

(21) Appl. No.: 14/145,916

(22) Filed: Dec. 31, 2013

(30) Foreign Application Priority Data
Apr. 26, 2013 (TW) 102207672

(51) Int. Cl. F16M 11/20

(52) U.S. Cl. CPC F16M 11/2021
USPC 248/346.06

(57) ABSTRACT

A support device includes a support base, an adjustment member, and a latching assembly. The support base defines a receiving groove, a cutout, and an operation hole. The cutout and the operation hole communicate with the receiving groove. The adjustment member is rotatably received in the receiving groove. The adjustment member includes a base body and an adjusting gear portion connected with the base body; and a latching assembly received in the receiving groove. The latching assembly includes a slider and a gear mounted on the slider, the slider comprises a main body, an operation portion, and an installation portion, the operation portion and the installation portion protrude from opposite end portions of the main body, the operation portion is received through the operation hole for slidably connecting with the operation hole, and the gear is movably assembled to the installation portion.

### BACKGROUND

1. Technical Field

The present disclosure generally relates to support devices, and particularly to a support device for supporting an electronic device.

2. Description of the Related Art

A support device for supporting an electronic device with a display, includes a support base and a plurality of adjustment members positioned on the support base. Each adjustment member forms an adjustment protrusion. A number of adjustment cutouts is defined in the support base engaging with the adjustment protrusions. One adjustment protrusion is latched in one adjustment cutout. However, the adjustment protrusion should first be detached from one adjustment cutout and then be latched in another adjustment cutout for adjusting angles or positions of the electronic device relative to the support base. It is thus not convenient for adjusting the viewing angles or positions of the electronic device relative to the support base.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a working state for a support device having an adjustment member and an anti-slipping member according to an embodiment.

FIG. 2 shows an exploded view of the support device of FIG. 1.

FIG. 3 is similar to the FIG. 2, but viewed from another aspect.

FIG. 4 is an isometric view of the adjustment member of the support device of the embodiment.

FIG. 5 is an isometric, assembled view of the support device of FIG. 3 with the anti-slipping member removed.

FIG. 6 is another working state for the support device of FIG. 1.

FIG. 7 is an isometric, assembled view of the support device of FIG. 6 with the anti-slipping member.

FIG. 8 is a cross-sectional view of the support device of FIG. 7 taken along line VIII-VIII.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

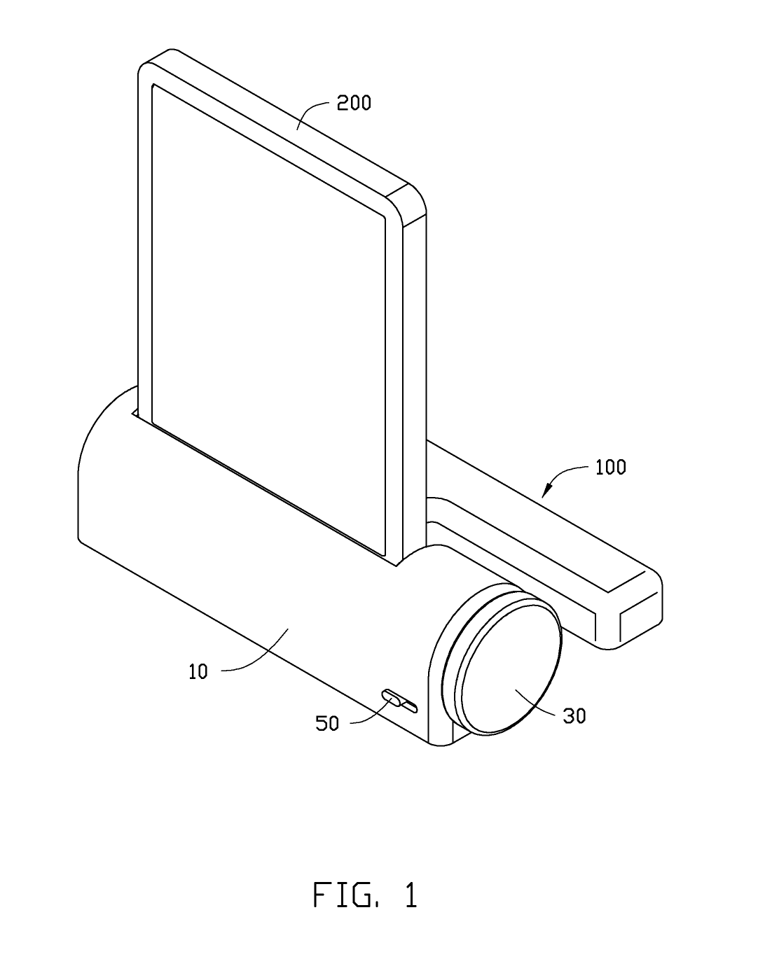

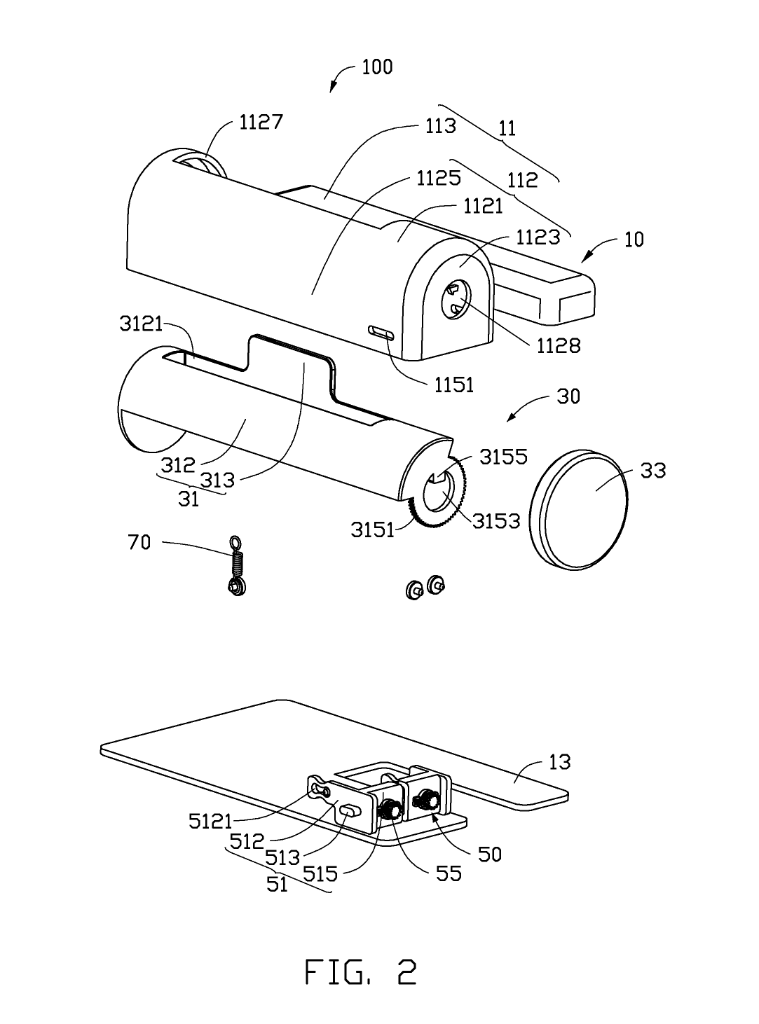

FIGS. 1 and 2 show a support device 100 200 in accordance with an embodiment of present invention. The support device 100 includes a support base 10, an adjustment assembly 30, two latching assemblies 50, and an elastic member 70. The electronic device 200 is an electronic device having a display, such as a mobile phone, a tablet computer, or a media player.

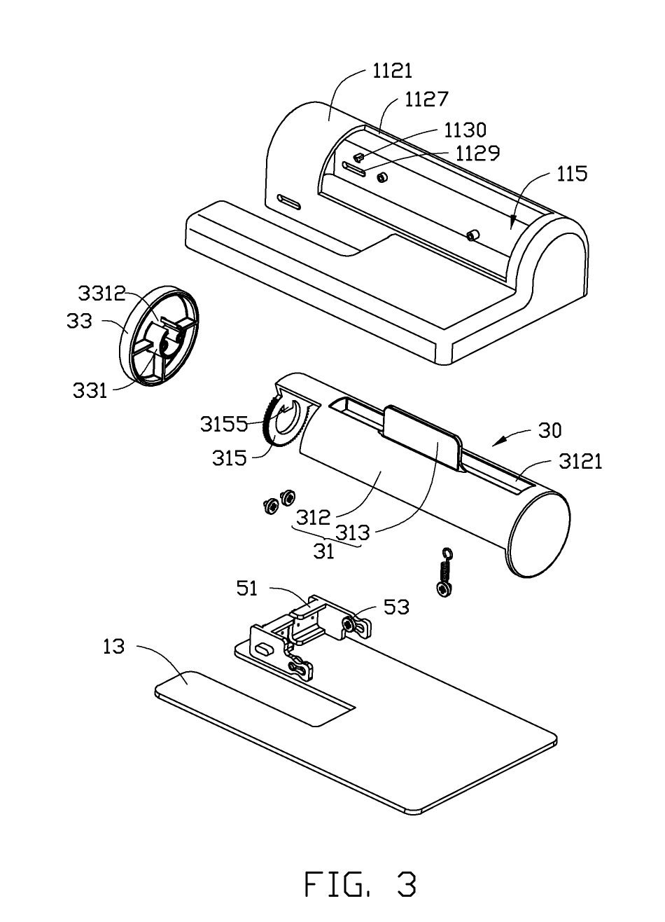

FIGS. 2 and 3 show that the support base 10 includes a support member 11 and an anti-slipping member 13 fixedly assembled to the support member 11. The support member 11 includes a mounting portion 112 and a support portion 113 connected to the mounting portion 112. The mounting portion 112 is a hollow structure and includes a top wall 1121, two first sidewalls 1123, and two second sidewalls 1125. The two first sidewalls 1123 and the two second sidewalls 1125 extend from edges of the top wall 1121. The two first sidewalls 1123 are parallel to each other. The top wall 1121, the two first sidewalls 1123, and the two second sidewalls 1125 cooperatively form a receiving groove 115. The top wall 1121 is a substantially arcuated surface.

A cutout 1127 is defined in the top wall 1121 and extends to one second sidewall 1125. A mounting hole 1128 is defined in one first sidewall 1123. An operation hole 1129 is defined in each second sidewall 1125 adjacent to the mounting hole 1128. The cutout 1127, the mounting hole 1128, and the operation holes 1129 communicate with the receiving groove 115, respectively. A support protrusion 1130 protrudes from an inner sidewall of each second sidewall 1125 adjacent to one corresponding operation hole 1129. The support portion 113 is substantially L-shaped and connects with an end of one second sidewall 1125 away from the operation hole 1129. The anti-slipping member 13 is fixedly connected to the support member 11 away from the top wall 1121 and covers the receiving groove 115. In the illustrated embodiment, the anti-slipping member 13 is made of silastic.

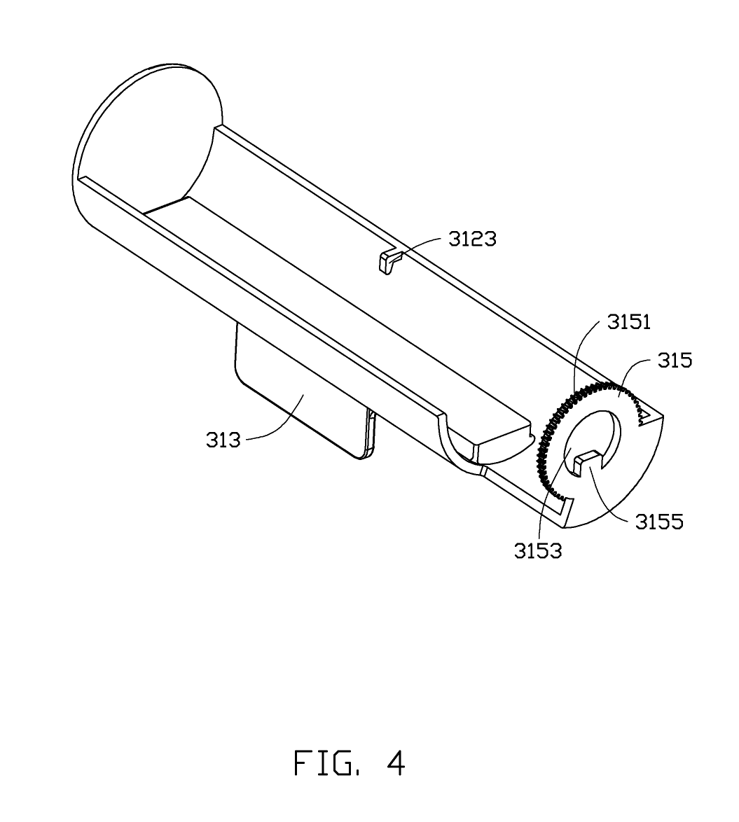

FIG. 2 through 4 show that the adjustment assembly 30 includes an adjustment member 31 and a rotating member 33 rotatably connected with the adjustment member 31. The adjustment member 31 is rotatably received in the receiving groove 115 and protrudes from the cutout 1127. The adjustment member 31 includes a base body 312, a holding portion 313, and an adjusting gear portion 315. The base body 312 defines a positioning hole 3121 communicating with the cutout 1127 to receive the electronic device 200. A hook 3123 protrudes from an edge of an inner wall of the base body 312 away from the top wall 1121 of the mounting portion 112. The adjusting gear portion 315 is positioned at one end portion of the base body 312 and abuts the cutout 1127. In the illustrated embodiment, the adjusting gear portion 315 and the base body 312 are integrated-body (integrally structured). In other embodiments, the adjusting gear portion 315 can be assembled to the base body 312. A penetrating hole 3153 is defined in the adjusting gear portion 315. A latching protrusion 3155 is formed in an inner wall of the penetrating hole 3153. The holding portion 313 protrudes from an edge of the positioning hole 3121 and is received through the cutout 1127 to hold the electronic device 200. The rotating member 33 includes a fixing portion 331 protruding from an end surface thereof and passing through the mounting hole 1128 and the penetrating hole 3153. The fixing portion 331 of the rotating member 33 defines a latching groove 3312 engaging with the latching protrusion 3155 of the adjusting gear portion 315 to assemble the rotating member 33 to the adjusting gear portion 315.

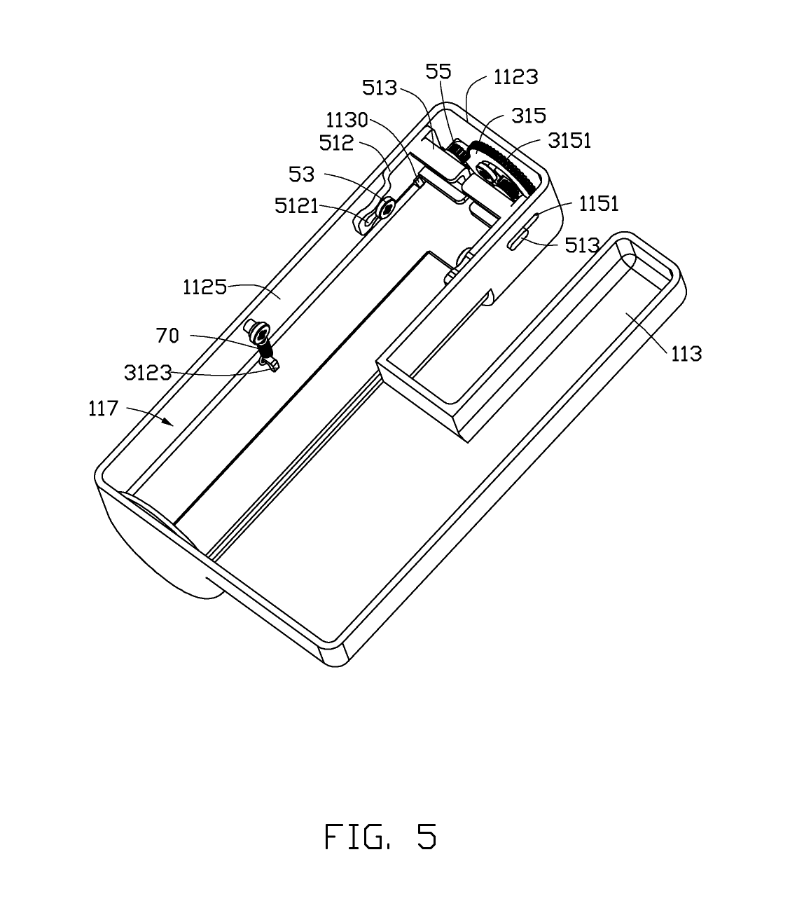

As shown in FIGS. 2, 3 and 5, the two latching assemblies 50 are respectively mounted on the two second sidewalls 1125. Each latching assembly 50 includes a slider 51, a connection member 53, and a gear 55. The slider 51 is slidably positioned on the second sidewall 1125 adjacent to the operation hole 1129. The connection member 53 is assembled to the slider 51. The gear 55 is rotatably positioned on the slider 51.

The slider 51 includes a main body 512, an operation portion 513, and an installation portion 515. The operation portion 513 and the installation portion 515 are positioned at two sides of the main body 512. The main body 512 is movably mounted on the support protrusion 1130 and abuts the mounting hole 1128. A sliding hole 5121 is defined in one end portion of the base body 512. The operation portion 513 movably extends through the operation hole 1129 and is exposed out of the support base 10. The installation portion 515 protrudes from a side surface of the main body 512 away from the operation portion 513. The connection member 53 passes through the sliding hole 5121 and is fixedly connected to the second sidewalls 1125, to assemble the main body 512 to the support base 10. The gear 55 is rotatably mounted on the installation portion 515 adjacent to the first sidewall 1123. The operation portion 513 is capable of moving the slider 51 towards the adjusting gear portion 315 for meshing with the gear 55. The rotating member 33 rotates relative to the support base 10 for adjusting the desired viewing angles or positions of the adjustment member 31. A torque force is applied by the gear 55 to the adjustment member 31 for controlling a rotating speed of the adjustment member 31 relative to the support base 10.

The elastic member 70 is received in the receiving groove 115. The elastic member 70 is fixedly connected to the second sidewall 1125 with a first end portion thereof, and is fixedly connected to the hook 3123 with a second end portion thereof, thereby helping the adjustment assembly 30 return to an original position when the gear 55 is detached from the adjusting gear portion 315. In the illustrated embodiment, a torque force applied to the adjustment member 31 by the gear 55 is greater than a resilient force produced by the elastic member 70.

In assembly, the base body 312 is rotatably received in the receiving groove 115, and the support portion 113 is received through the cutout 1127. The fixing portion 331 is rotatably received through the mounting hole 1128 and the penetrating hole 3153. The latching portion 3155 of the adjusting gear portion 315 is engaged in the latching groove 3312 of the rotating member 33. The main body 512 is movably assembled to the support protrusion 1130. The operation portion 513 movably passes through the operation hole 1129 and protrudes from the support base 10. The connection member 53 passes through the sliding hole 5121 and is connected to the second sidewall 1125. The elastic member 70 is received in the receiving groove 115, and is connected between the second sidewall 1125 and the hook 3123. The anti-slipping member 13 is fixedly mounted on the support member 11 covering the receiving groove 115.

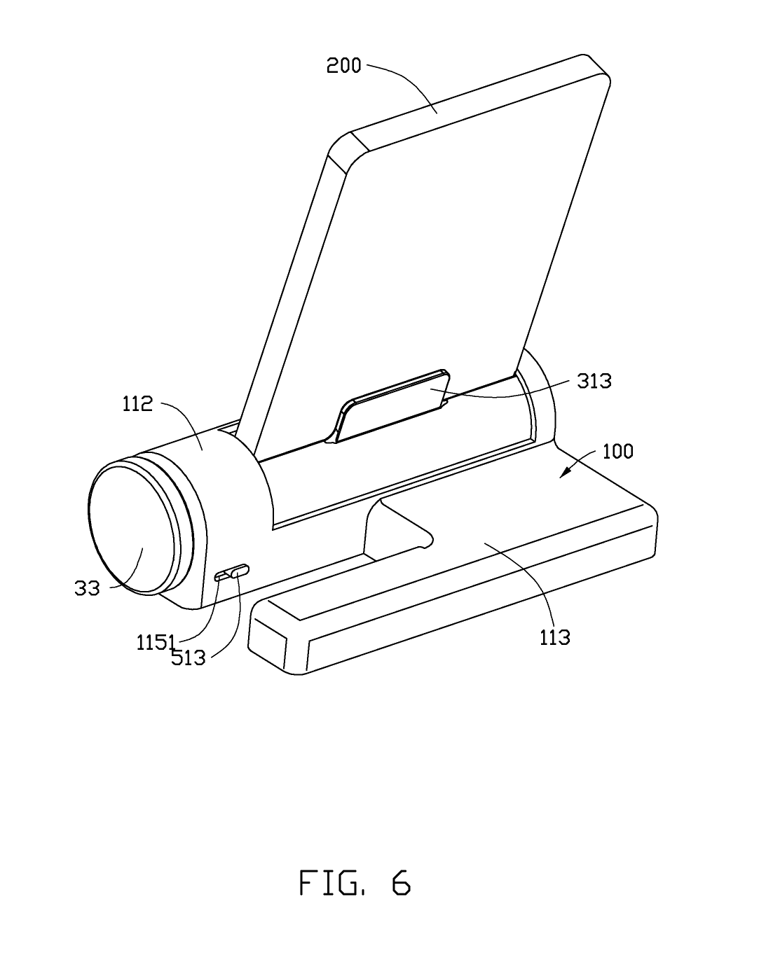

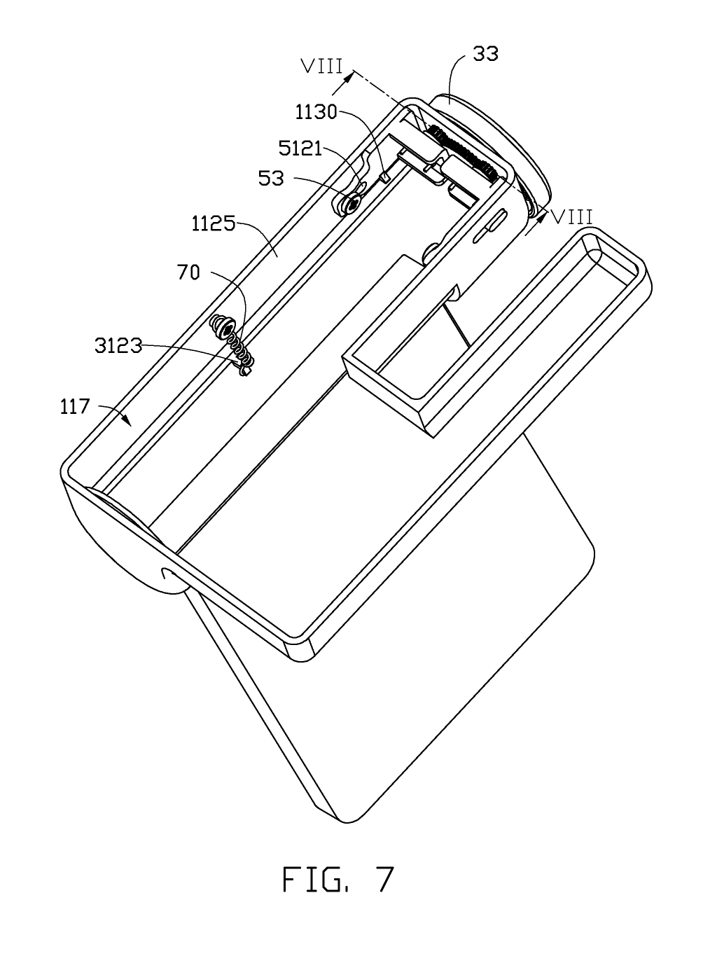

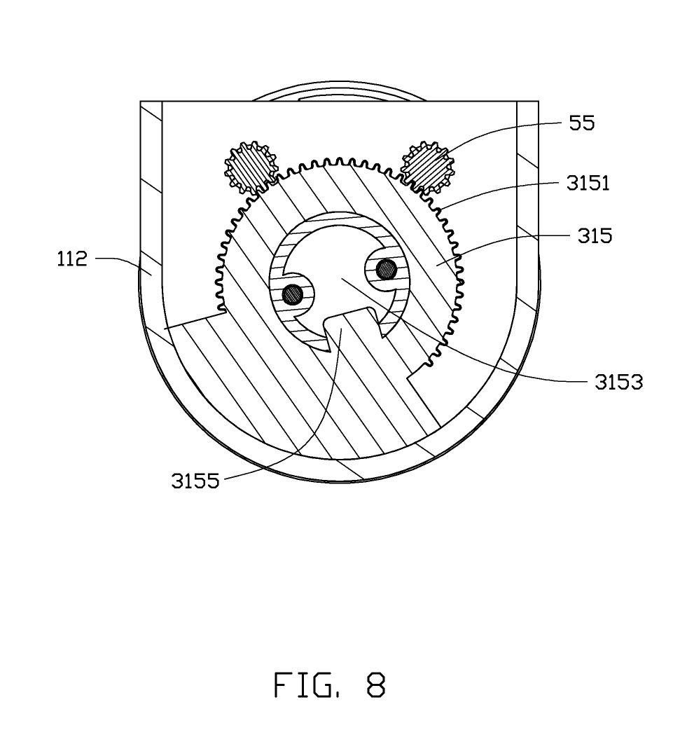

In use, as shown in the FIGS. 6 to 8, the electronic device 200 is inserted into the positioning hole 3121 via the cutout 1127 and is supported by the holding portion 313 of the adjustment member 31. The adjustment member 31 can be adjusted as follows. The rotating member 33 is rotated relative to the support base 10 causing the adjustment member 31 to arrive at a first position. One operation portion 513 is pushed to slide along the operation hole 1129 until the gear 55 is meshed with the adjusting gear portion 315. The rotating member 33 is rotated until the adjustment member 31 is positioned at a second position, and pushing another operation portion 513 to slide along the operation hole 1129 until the corresponding gear 55 is meshed with the adjusting gear portion 315 to supply another resistance force to the adjusting gear portion 315. The rotating member 33 is rotated until the adjustment member 31 is positioned at a third desired position. In the illustrated embodiment, the adjustment member 31 and the electronic device 200 arrive at the third desired position via the rotation of the rotating member 33 being performed three times. In other embodiments, an operator operates the rotating member 33 and the two operation portions 513 according to the desired position.

If not being used, the two operation portions 513 are brought to return to their original positions along the operation hole 1129, and the gears 55 are detached from the adjusting gear portion 315. The adjustment member 31 returns to its original position because of the resilience force produced by the elastic member 70.

As described above, the rotating member 33 can be directly rotated to adjust the viewing angles or positions of the electronic device 200. The gears 55 are meshed with the adjusting gear portion 315 for a more stable rotation of the rotating member 33.

In other embodiments, the number of the latching assembly 50 is not limited to two, so that it can be one, three or more. The rotation member 33 can be omitted, and the adjustment member 31 can be directly rotated for adjusting positions. The anti-skipping member 13 can be omitted. The connection member 53 can be omitted, and a rail or other similar structures is formed on the second sidewall 1125 to engage with the slider 51. The latching protrusions 3155 and the latching groove 3312 can be omitted, and the fixing portion 331 is fixed to the adjusting gear portion 315 via a fastener.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A support device for supporting an electronic device comprising:
a support base defining a receiving groove, a cutout, and an operation hole, the cutout and the operation hole communicating with the receiving groove;
an adjustment member rotatably received in the receiving groove, the adjustment member comprising a base body and an adjusting gear portion connected with the base body; and
a latching assembly received in the receiving groove, wherein the latching assembly comprises a slider and a gear mounted on the slider, the slider comprises a main body, an operation portion, and an installation portion, the operation portion and the installation portion protrude from opposite sides of the main body, the operation portion is received through the operation hole for slidably assembling of the slider to the support base, and the gear is assembled to the installation portion, the operation portion is capable of sliding along the operation hole to enable the gear mesh with the adjusting gear portion, thereby positioning the adjustment member at a desired position relative to the support base.

2. The support device of claim 1, wherein the support device further comprise an elastic member received in the receiving groove, and the elastic member is connected between an inner wall of the receiving groove and the base body.

3. The support device of claim 1, wherein the support base comprises a support member and an anti-slipping member mounted on the support member.

4. The support device of claim 1, wherein the support base comprises a mounting portion and a support portion connected to the mounting portion, and the receiving groove, the cutout, and the operation hole are defined in the mounting portion.

5. The support device of claim 4, wherein the mounting portion comprises a top wall, two first sidewalls, and two second sidewalls, the two first sidewalls and the two second sidewalls extend from edges of the top wall, the top wall, the two first sidewalls, and the two second sidewalls cooperatively form the receiving groove, the cutout is defined in the top wall, the operation hole is defined in one second sidewall.

6. The support device of claim 5, wherein a support protrusion protrudes from an inner sidewall of one second sidewall to connect with the main body.

7. The support device of claim 1, wherein the support device further comprise a rotating member, the support base further defines a mounting hole adjacent to the adjusting gear portion, the rotating member passes through the mounting hole and is connected with the adjusting gear portion.

8. The support device of claim 7, wherein the rotating member comprises a fixing portion protruding from an end surface of the rotating member, the fixing portion passes through the mounting hole and defines a latching groove, the latching protrusion is formed in the adjusting gear portion, the latching protrusion is engaged with the latching groove.

9. The support device of claim 1, wherein the adjustment member further comprises a holding portion protruding from a top portion of the adjustment member to hold the electronic device.

10. The support device of claim 1, wherein the base body defines a positioning hole communicating with the cutout to receive the electronic device.

11. A support device for supporting an electronic device comprising:
a support base defining a receiving groove, a cutout, and an operation hole, the cutout and the operation hole communicating with the receiving groove;
an adjustment member rotatably received in the receiving groove, the adjustment member comprising a base body and an adjusting gear portion, the base body and the adjusting gear portion being an integrated body; and
a latching assembly received in the receiving groove, wherein the latching assembly comprises a slider and a gear mounted on the slider, the slider comprises a main body, an operation portion, and an installation portion, the operation portion and the installation portion protrude from opposite sides of the main body, the operation portion is received through the operation hole for slidably connecting with the operation hole, and the gear is assembled to the installation portion, the operation portion is capable of sliding along the operation hole to enable the gear mesh with the adjusting gear portion thereby positioning the adjustment member relative to the support base.

12. The support device of claim 11, wherein the support device further comprise an elastic member received in the receiving groove, and the elastic member is interconnected to an inner wall of the receiving groove and the base body.

13. The support device of claim 11, wherein the support base comprises a support member and an anti-slipping member mounted on the support member.

14. The support device of claim 11, wherein the support base comprises a mounting portion and a support portion connected to the mounting portion, and the receiving groove, the cutout, and the operation hole are defined in the mounting portion.

15. The support device of claim 14, wherein the mounting portion comprises a top wall, two first sidewalls, and two second sidewalls, the two first sidewalls and the two second sidewalls extend from edges of the top wall, the top wall, the two first sidewalls, and the two second sidewalls cooperatively form the receiving groove, the cutout is defined in the top wall, and the operation hole is defined in one second sidewall.

16. The support device of claim 15, wherein a support protrusion protrudes from an inner sidewall of one second sidewall to connect with the main body.

17. The support device of claim 11, wherein the support device further comprise a rotating member, the support base further defines a mounting hole adjacent to the adjusting gear portion, the rotating member passes through the mounting hole and is connected with the adjusting gear portion.

18. The support device of claim 17, wherein the rotating member comprises a fixing portion protruding from an end surface of the rotating member, the fixing portion passes through the mounting hole and defines a latching groove, the latching protrusion is formed in the adjusting gear portion, the latching protrusion is engaged with the latching groove.

19. The support device of claim 11, wherein the adjustment member further comprises a holding portion protruding from a top portion of the adjustment member to hold the electronic device.

20. The support device of claim 11, wherein the base body defines a positioning hole communicating with the cutout to receive the electronic device.
